(19) United States
(12) Patent Application Publication
(10) Pub. No.: US 2026/0318442 A1
(43) Pub. Date: Oct. 15, 2026

(54) UNIVERSAL AUTOMATED REGULATOR VALVE WITH REMOTE MONITORING AND CONTROL CROSS REFERENCE TO RELATED APPLICATIONS

(71) Applicant: Hadi Said Hillo, Agua Dulce, CA (US)

(72) Inventor: Hadi Said Hillo, Agua Dulce, CA (US)

(21) Appl. No.: 19/466,488

(22) Filed: Feb. 1, 2026

Related U.S. Application Data
(63) Continuation-in-part of application No. 17/961,334, filed on Oct. 6, 2022, now Pat. No. 12,540,687.
Application No. 17/961,334 is a continuation of application No. 17/213,495, filed on Mar. 26, 2021, now abandoned.

(51) Int. Cl. F16K 37/00; F16K 31/04; G08B 21/12; H04W 4/80; H04W 84/12

(52) U.S. Cl. CPC F16K 37/005; F16K 31/04; F16K 31/041; F16K 31/042; G08B 21/12; H04W 4/80; H04W 84/12

(57) ABSTRACT

The embodiments disclose a digital automated regulation device for a fluid pipeline includes a digital regulation device controller coupled to an electronically actuated ball valve, an electrical motor, and a relay, a plurality of sensors, including fluid leak sensors, a pressure sensor, a flow-rate sensor, and a temperature sensor, are coupled to the controller to monitor operating conditions of a fluid conveyed through the pipeline, at least one of the fluid leak sensors is wireless and positioned along an exterior of the pipeline, an automated regulator monitors sensor data and, upon detection of a leak or abnormal pressure, flow, or temperature condition, actuates the electronically actuated ball valve to regulate or interrupt fluid flow, the device provides automated protection against leaks and abnormal fluid conditions while maintaining predetermined operating parameters without requiring user intervention.

### CROSS REFERENCE TO RELATED APPLICATIONS

This application is a continuation-in-part of U.S. nonprovisional application Ser. No. 17/961,334, filed on Oct. 6, 2022, which is a continuation of U.S. nonprovisional application Ser. No. 17/213,495, filed on Mar. 26, 2021, which is a continuation of U.S. nonprovisional application Ser. No. 15/348,703, filed on Nov. 10, 2016, and issued as U.S. Pat. No. 10,962,133, which claims priority to U.S. Provisional Application 62/255,020 filed on Nov. 13, 2015, which are all incorporated herein by reference.

### TECHNICAL FIELD

The present disclosure pertains to valve control systems and particularly relates to a universal automated regulator valve constructed to maintain a set pressure and stop flow through the valve when the flow pressure is higher or lower than the set pressure.

### BACKGROUND

Conventional fluid regulation systems used in residential, commercial, and industrial buildings typically rely on passive mechanical regulators and manual shutoff valves that do not actively monitor operating conditions or automatically respond to abnormal events. Failures of these systems, including undetected leaks, pressure spikes, excessive flow conditions, or temperature-related faults, can result in uncontrolled fluid discharge that causes structural damage, property loss, and unsafe conditions within a building. Existing systems further lack coordinated sensor-based control and remote monitoring capabilities, limiting their ability to prevent damage once abnormal conditions occur.

### SUMMARY OF THE INVENTION

The present disclosure relates to a universal automated regulator valve, which is used for controlling water, gas, air, or fluids regulated by pressure, flow, temperature. The system of the present invention can be electronically controlled with an artificial intelligence processor, such as a Pinoccio system. The universal automated regulator valve includes an electronically actuated ball valve that is connected to an electrical motor, a relay, and the electrical pressure sensor switch. When the electrical pressure sensor is actuated, the relay goes into a closed state, and consequently the electrical motor closes the ball valve. The electrical pressure sensor switch is versatile and programmable and can control gas and liquid fluids including water, natural gas, and air.

In certain embodiments, the automated regulator valve control includes a communications device that transmits pressure readings of the electrical pressure sensor switch to a remote device (Pinoccio) which can then be controlled by cell, iPad, or computer to control the electrical motor to close or open the ball valve. In other embodiments, the pressure regulator is to maintain a set pressure. In most cases, below 80 psi for water and gas at roughly 7 psi as examples of pressure settings for regulators. Pressure regulator is configured to maintain a set pressure, from the set pressure occurs, the ball valve is triggered to shut off flow to the valve or if the user wants email and text or just email and text and not shut the valve off it is programmable to do any of them at once or in any configuration.

In certain embodiments, the digital automated regulation device includes a digital regulation device controller that is operatively coupled to at least one electronically actuated ball valve, an electrical motor, and a relay. The controller is configured to receive sensor data and to coordinate actuation of the electrical motor through the relay in order to open or close the electronically actuated ball valve. The electronically actuated ball valve is positioned inline with a pipeline conveying a fluid and is configured to physically regulate fluid flow through the pipeline in response to control signals generated by the controller and an automated regulator.

In certain embodiments, the electronically actuated ball valve includes a ball disposed within the ball valve body, the ball having a borehole extending there through. The ball is rotatable by the electrical motor between a closed position and a fully open position, as well as one or more partially open positions. When the ball is in the fully open or partially open position, fluid is permitted to pass through the borehole, and when the ball is in the closed position, fluid flow through the borehole is prevented. By selectively rotating the ball to a partially open position, the automated regulator is capable of adjusting fluid pressure and flow rate within the pipeline without fully shutting off fluid flow.

The system further includes a plurality of fluid leak sensors coupled to the digital regulation device controller and positioned along an exterior surface of the pipeline. These fluid leak sensors are configured to detect the presence of fluid external to the pipeline, thereby indicating a leak condition along the pipeline. In some embodiments, at least one of the plurality of fluid leak sensors is a wireless leak sensor, allowing placement at locations remote from the electronically actuated ball valve while remaining communicatively coupled to the controller. At least one leak sensor is attached directly to an outside surface of the pipeline.

A temperature sensor is coupled to the digital regulation device controller and is configured to measure a temperature of the fluid within the pipeline at a predetermined time or over predetermined intervals. Temperature measurements are evaluated by the controller and the automated regulator to determine whether the fluid temperature is within a predefined acceptable range. Deviations in temperature are used as an indication of abnormal operating conditions or leak-related events.

The digital automated regulation device also includes a pressure sensor coupled to the digital regulation device controller. The pressure sensor includes an electrical pressure sensor switch and is configured to measure a pressure of the fluid in the pipeline at a predetermined time or continuously. When measured pressure exceeds or falls below a predetermined set threshold value, the electrical pressure sensor switch generates a control signal that is received by the automated regulator and used to initiate actuation of the electronically actuated ball valve through the relay and electrical motor.

In addition, a flow-rate sensor is coupled to the digital regulation device controller and configured to measure a flow rate of the fluid within the pipeline at a predetermined time or continuously. In some embodiments, the flow-rate sensor continuously measures fluid flow, and when the measured flow rate exceeds a predetermined maximum flow rate, the flow-rate sensor signals the controller and automated regulator to initiate closure of the electronically actuated ball valve. Flow-rate data may also be used to determine fluid usage over time.

An automated regulator is coupled to the digital regulation device controller, the electrical motor, the relay, and the electrical pressure sensor switch. The automated regulator is configured to monitor discrepancies in pressure and flow rate of the fluid relative to predetermined set threshold values. Based on these monitored discrepancies, the automated regulator electronically controls actuation of the electrical motor via the relay to open or close the electronically actuated ball valve. In certain embodiments, the electronically actuated ball valve includes a pressure sensor on an inlet side and a pressure sensor on an outlet side, enabling the automated regulator to balance overall fluid pressure across the valve during operation.

When monitored discrepancies in pressure or flow rate exceed predetermined threshold values, the automated regulator actuates the electrical motor to open or close the electronically actuated ball valve in order to regulate pressure and flow rate of the fluid within the pipeline. The automated regulator is further configured to open or close the electronically actuated ball valve when at least one of the plurality of fluid leak sensors senses a leak condition based on at least one predefined pressure value, flow value, or temperature value of the fluid in the pipeline. In this manner, the system regulates fluid flow to maintain predetermined set temperature, pressure, and flow-rate conditions within the pipeline.

In some embodiments, the digital automated regulation device further includes an automated digital regulation device application operating on a user's mobile device. The digital regulation device controller is configured to be remotely monitored and controlled by the mobile device through the application. Sensor data received from the pressure sensor, flow-rate sensor, temperature sensor, and fluid leak sensors is transmitted to the mobile device and displayed to the user.

The automated digital regulation device application is configured to transmit text message alerts to the user's mobile device when one or more preset parameters are activated. In addition, the automated digital regulation device is configured to transmit email notifications to the user detailing the conditions that triggered activation of at least one preset parameter. The application further transmits alerts to the user indicating that current fluid movement conditions are not within preset parameters.

If the automated digital regulation device fails to adjust and maintain the preset parameters within acceptable ranges, the system is configured to automatically shut down fluid flow by closing the electronically actuated ball valve and to transmit alerts to the user via text message and email. The application is further configured to receive sensor data, including pressure sensing data, and display such data on the user's mobile device to allow the user to review real-time and historical operating conditions.

In certain embodiments, the digital regulation device controller is further coupled to a remote server that performs advanced data analysis using statistical modeling or machine-learning techniques to dynamically adjust fluid flow or pressure parameters. Control signals generated by the remote server are transmitted back to the digital regulation device controller to assist in refining threshold parameters and regulating operation of the electronically actuated ball valve during normal usage conditions.

The digital automated regulation device is used in residential homes, farms, and commercial buildings and regulates fluids including water, gas, petroleum oil, natural gas, liquid propane, and diesel fuel, as well as other fluids capable of being pressurized and controlled. In some embodiments, at least one of the plurality of sensors is configured to identify a location along the pipeline at which a leak is detected, thereby facilitating rapid location and repair of the leak.

### BRIEF DESCRIPTION OF THE DRAWINGS

These and other features, aspects, and advantages of the present disclosure will become better understood with regard to the following description, and accompanying drawings where:

FIG. 1 illustrates an embodiment of a universal automated regulator valve without a pressure regulator attached.

FIG. 2 is an exploded view of the device of FIG. 1.

FIG. 3 illustrates an exemplary electrical wiring diagram of the device of FIG. 1.

FIG. 4 illustrates another embodiment of a universal automated regulator valve.

FIG. 5 illustrates universal automated regulator valve of FIG. 4 connected to a solar panel.

FIG. 6 illustrates another embodiment of a universal automated regulator valve with network connectivity.

FIG. 7 is an exploded view of the device of FIG. 6.

FIG. 8 is a universal automated regulator valve with a pressure regulator.

FIG. 9 is an exploded view of the universal automated regulator valve of FIG. 8.

FIG. 10 is a side view of the universal automated regulator valve of FIG. 8.

FIG. 11 is a front view of the universal automated regulator valve of FIG. 8.

FIG. 12 is an embodiment of a pressure regulator that is used with the universal automated regulator valve of FIG. 8.

FIG. 13 is another pressure regulator that is used with the universal automated regulator valve of FIG. 8.

FIG. 14 is another pressure regulator that is used with the universal automated regulator valve of FIG. 8.

FIG. 15 is an electronic ball valve that is used with the universal automated regulator valve of FIGS. 1, 4, and 8.

FIG. 16 is a gas sensor that is used with the universal automated regulator valve of FIGS. 1, 4, and 8.

### DETAILED DESCRIPTION OF THE INVENTION

As required, detailed embodiments of the present invention are disclosed herein; however, it is to be understood that the disclosed embodiments are merely exemplary of the invention that is embodied in various and alternative forms. The figures are not necessarily to scale; some features are exaggerated or minimized to show details of particular components. Therefore, specific structural and functional details disclosed herein are not to be interpreted as limiting, but merely as a representative basis for teaching one skilled in the art to variously employ the present invention.

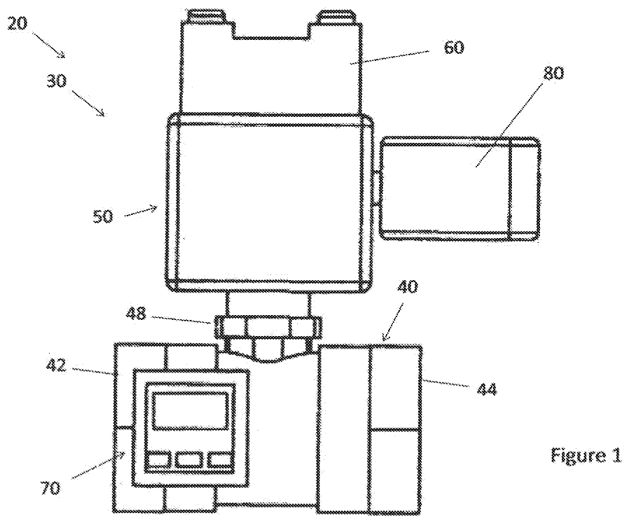

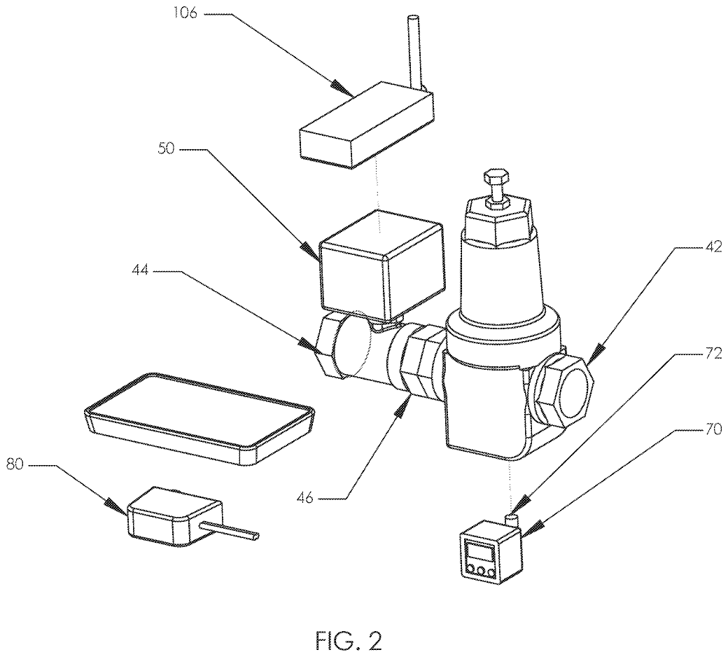

FIGS. 1 and 2 show an embodiment of a universal automated regulator valve 20. The universal automated regulator valve 20 comprises an electronically actuated ball valve 30, an electrical pressure sensor 70, and a power supply switch 80. The electronically actuated ball valve 30 includes a ball valve 40, an electrical motor 50, and a relay 60. The electronically actuated ball valve 30 and the electrical pressure sensor 70 are wired together to a source of electrical power inside the power supply switch 80. An exemplary wiring diagram is shown in FIG. 2.

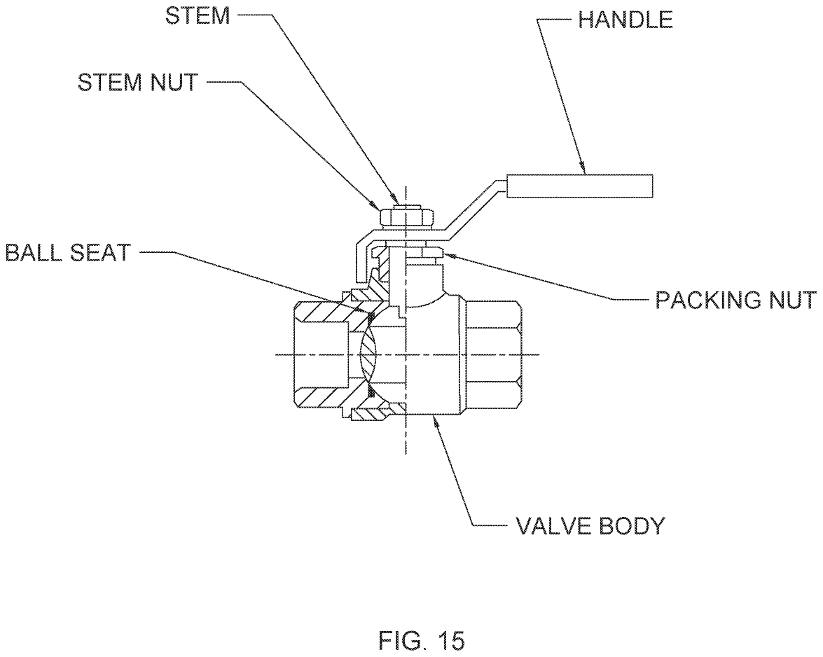

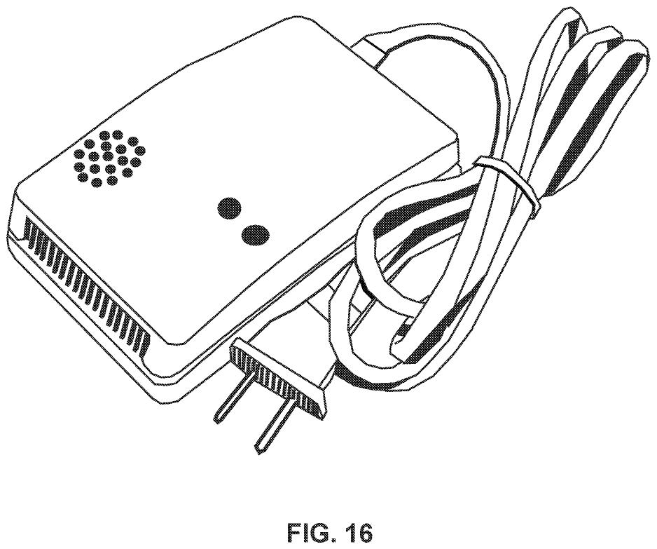

The ball valve 40 includes an inlet opening 42 on one of its sides and an outlet opening 44 on its other side. A fluid enters the ball valve 40 through the inlet opening 42 and exits the ball valve 40 through the outlet opening 44. The ball valve 40 further includes a threaded sensor mounting hole 46, a motor mounting interface 48 (shown in FIG. 1), and a floating ball (not shown). The electrical motor 50 is attached to the ball valve 40 at the motor mounting interface using screws, threads, or bolts. The electrical motor 50 includes a shaft (not shown) which is connected to the floating ball of the ball valve 40. The relay 60 is fixed over the electrical motor 50, on the opposite side where the electrical motor 50 is mounted on the ball valve 40, and the power supply switch 80 is attached to a side of electrical motor 50. As a non-limiting example, the electronically actuated ball valve 30 is an electric valve sold by BANJO Company, located in Crawfordsville, Ind. Another ball valve that is used is shown in FIG. 15. The ball valve described in Attachment A can also be used.

The electrical pressure sensor 70 includes a mounting thread 72, which is used to install the electrical pressure sensor 70 on the ball valve 40 at the threaded sensor mounting hole 46. Furthermore, the electrical pressure sensor 70 is set to a predetermined maximum pressure level. The fluid pressure is continuously measured by the electrical pressure sensor 70, and in the case of the fluid pressure excess from the predetermined maximum pressure level, the electrical pressure sensor 70 is activated, then the relay 60 is energized, causing the electrical motor 50 to be actuated, and consequently the shaft of the electrical motor 50 turns the floating ball and the ball valve 40 is closed. As a non-exclusive example, the electrical pressure sensor 70 is a digital pressure switch for positive pressure sold by SMC Company, located in Noblesville, Ind.

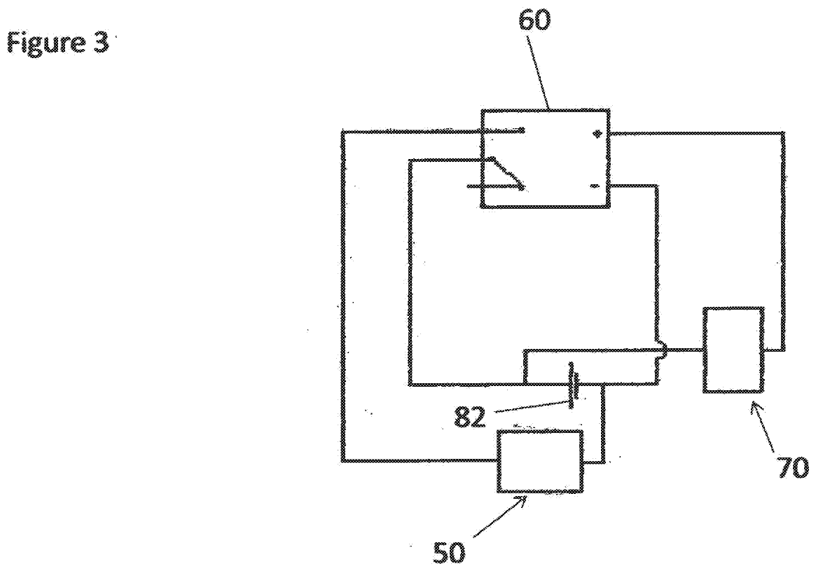

FIG. 3 shows an exemplary wiring diagram of the universal automated regulator valve 20 shown in FIG. 1. When the fluid pressure exceeds the predetermined maximum pressure level, the electrical pressure sensor 70 closes the circuit and sends an electrical current to the relay 60. As it is illustrated in FIG. 3, initially the relay is in a normally open state, however received electrical current from the electrical pressure sensor changes the state of the relay 60, and consequently electrical motor 50 is actuated. As it is illustrated in FIG. 3, a battery 82 is utilized as a source of electrical power. Alternatively, other sources of electricity including solar batteries or an electrical outlet is used.

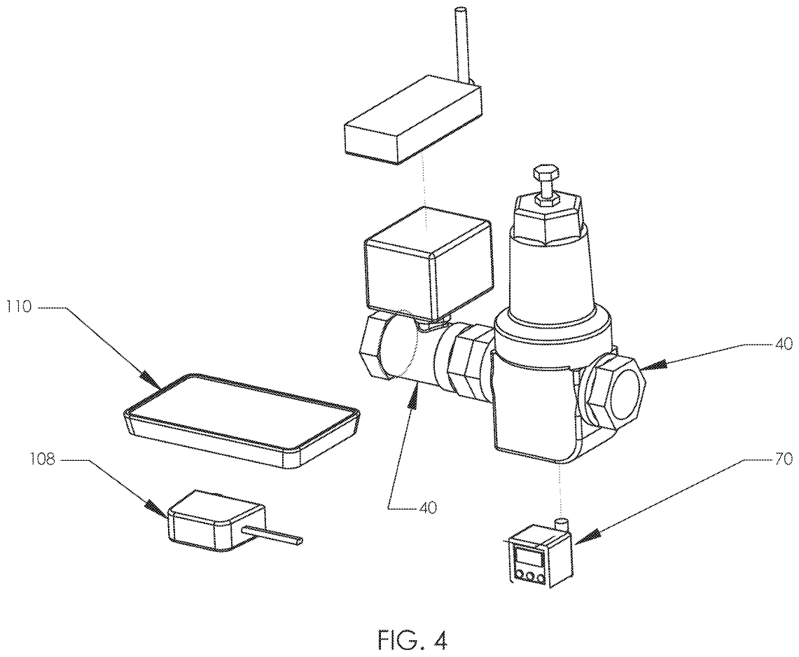

In another embodiment as it is shown in FIG. 4, there are inlet 90 and outlet 92 pipe nipples present. The inlet pipe nipple 90 is attached to the ball valve 40 at the inlet opening 42, and accordingly the outlet pipe nipple 92 is attached to the ball valve 40 at the outlet opening 44. The inlet pipe nipple 90 may have a threaded hole (not shown), where the mounting thread (not shown in FIG. 4) of the electrical pressure sensor 70 is installed. Therefore in this particular embodiment the pressure of the fluid in the inlet pipe nipple 90 is monitored.

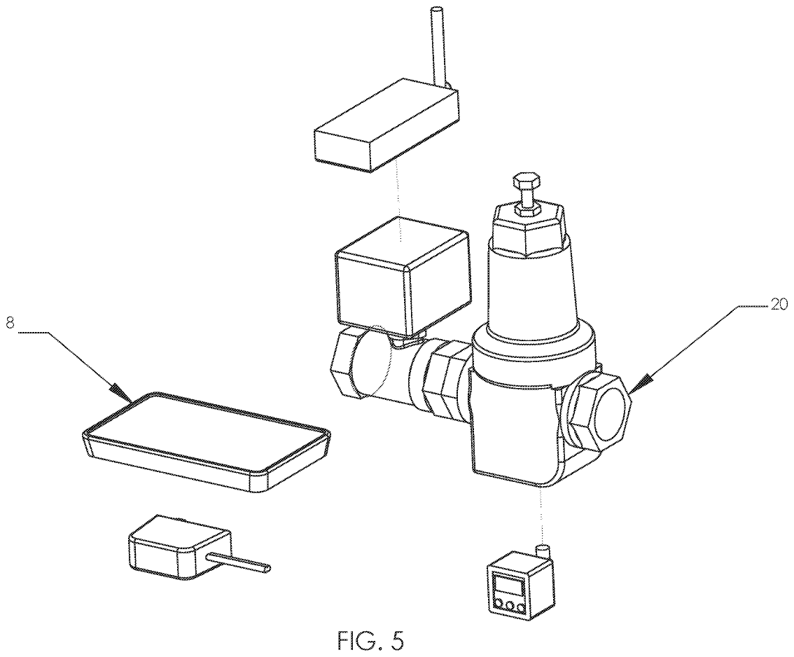

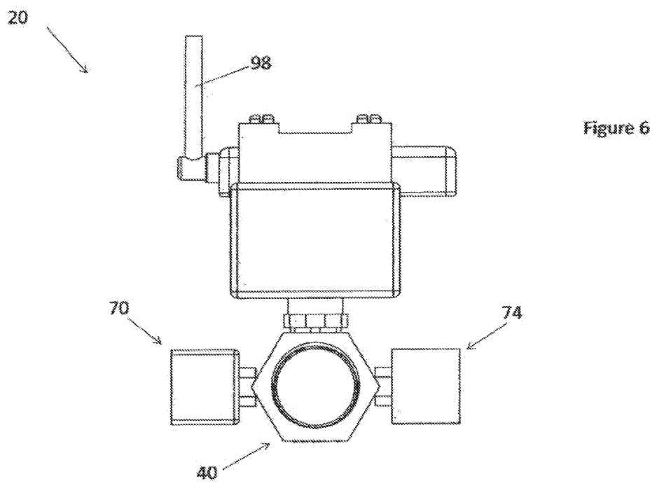

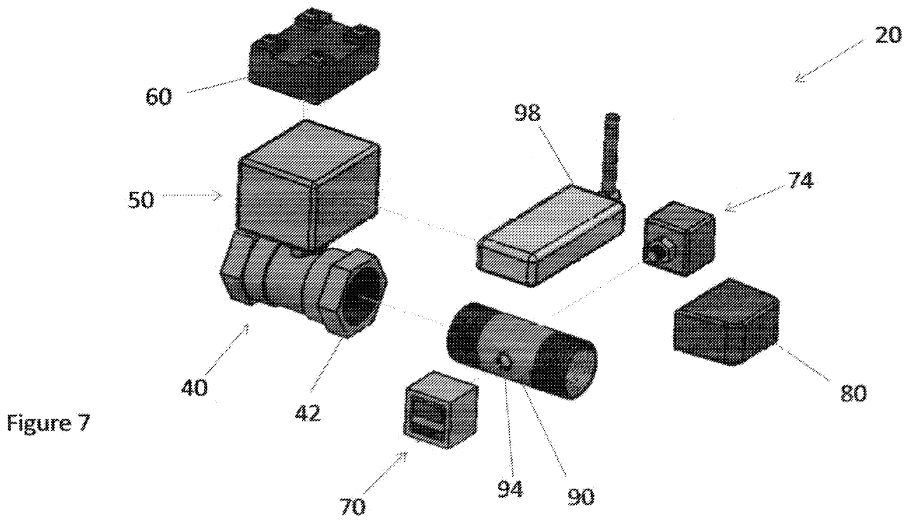

FIG. 5 shows the universal automated regulator valve 20 connected to a solar panel 84. This embodiment is beneficial in remote areas, where changing batteries are difficult or there is no electricity network. FIGS. 6 and 7 show a universal automated regulator valve 20 according to certain embodiments of the present disclosure. As it is shown there is an inlet pipe nipple 90 (shown in FIG. 7), which is attached to the ball valve 40 at the inlet opening 42. The inlet pipe nipple 90 may have two threaded holes 94 (in FIG. 7 one of them is shown). The electrical pressure sensor 70 is attached to the inlet pipe nipple 90 at one of the threaded holes 94 and a flow sensor 74 is attached to the other threaded hole (not shown). In this embodiment the universal automated regulator valve 20 is controlled by both the electrical pressure sensor 70 and the flow sensor 74. Accordingly, the flow sensor 74 is set to a predetermined maximum flow rate. Furthermore, the flow rate of the fluid in the inlet pipe nipple 90 is continuously measured by the flow sensor 74, and whenever the flow rate exceeds the predetermined maximum flow rate, the flow sensor 74 is activated, and consequently the ball valve 40 is closed. Alternatively, various types of sensors including but not limited to pressure sensors, flow sensors, timers, vacuum sensors, temperature sensors, or any combination of them are used to control the universal automated regulator valve 20.

Wireless control and monitoring is performed using communications device that adopts any of a number of well-known protocols, including through a Bluetooth connection or Wi-Fi connection over a local or wide area network, including the internet. As shown in FIGS. 6 and 7, the universal automated regulator valve further includes a Wi-Fi Bluetooth control unit Pinoccio as a reference others may be used, connection 98 enabling remote monitoring and control of the device.

Pinoccio is an open-source electronic system designed for building low-power, wireless sensor networks, particularly for environmental monitoring, home automation, and Internet-of-Things (IoT) projects. It is centered around small, Arduino-compatible microcontroller boards equipped with built-in radios (typically based on mesh networking), allowing many nodes to communicate with each other and with a central gateway over long distances while consuming very little power. Pinoccio emphasizes ease of deployment and scripting, enabling developers to remotely program, manage, and collect data from distributed devices without complex infrastructure, making it well suited for prototyping and educational use in connected systems.

In one embodiment, the Pinoccio system is further operatively connected to a remote computing system capable of performing advanced data analysis, including machine learning or artificial intelligence based processing, using sensor data transmitted from one or more Pinoccio-enabled devices. Sensor data including pressure, flow rate, temperature, leak detection, and usage patterns are aggregated and analyzed over time by the remote computing system to identify patterns, anomalies, predictive conditions, or optimized control parameters. Based on this analysis, the remote computing system generates control instructions, parameter updates, or threshold adjustments, which are transmitted back to the Pinoccio system. The Pinoccio system then executes the received instructions locally to the digital regulation device controller to control one or more actuators, including opening or closing an electronically actuated ball valve, transmitting alerts, or modifying operating parameters, while maintaining low-power operation and real-time responsiveness at the edge device level. For example, AI analysis of current usage levels compared to learned pressure levels, flow rates, and temperature changes and their duration during normal uses of the fluid system may distinguish the current use as a normal use fluctuation rather than a leak condition and instruct the Pinoccio system not to close the electronically actuated ball valve based on the pipeline fluctuations. This will prevent the water flow from premature closure disrupting normal usage during, for example, someone taking a shower, or washing dishes.

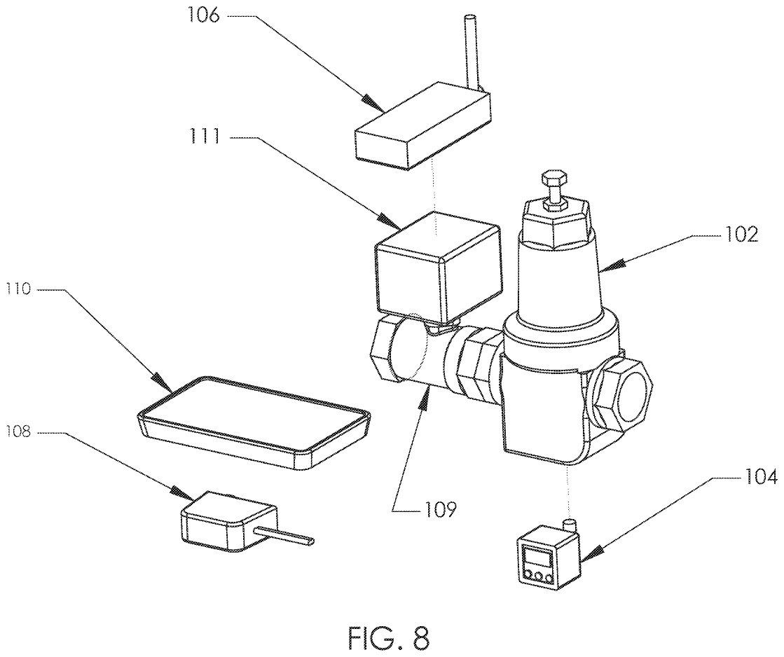

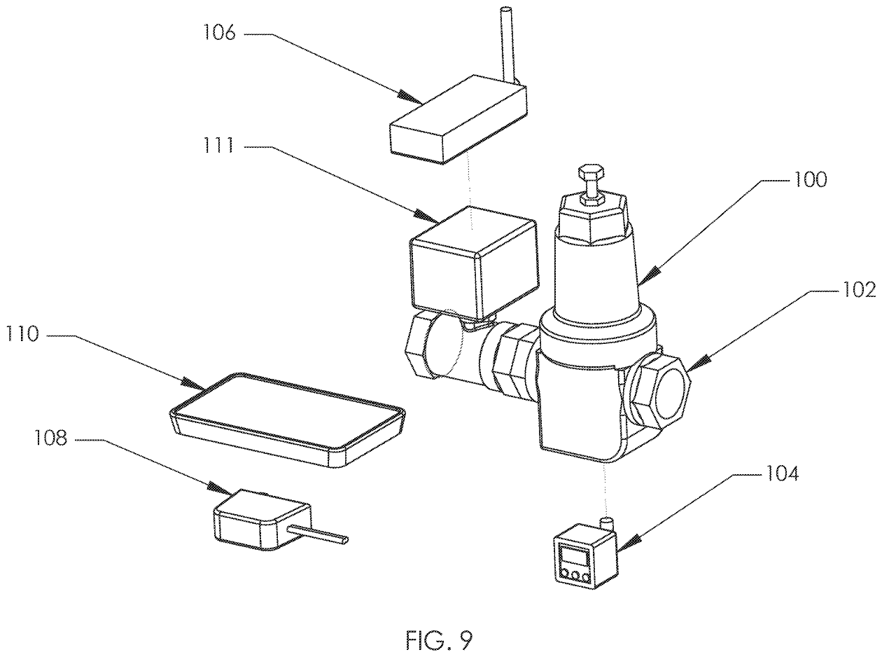

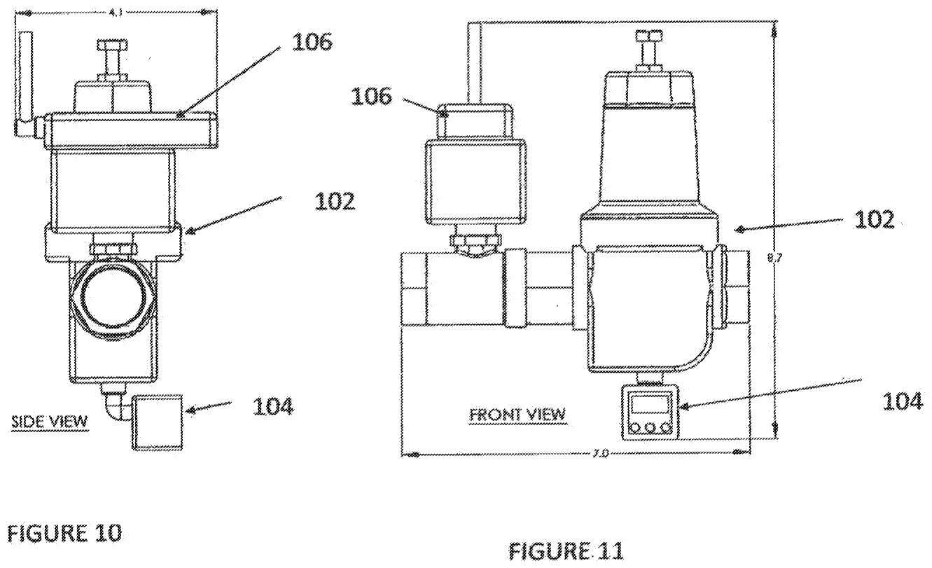

Referring now to FIGS. 8-11, an embodiment of a universal automated regulator valve 100 with a pressure regulator 102 is shown. The pressure regulator 102 is a pressure retaining valve, a pressure reducing valve, a single stage pressure regulator, a dual stage pressure regulator, and other pressure regulators known in the art. A pressure and flow sensor 104 is attached to the pressure regulator 102. The universal automated regulator valve 100 further includes a power supply 108, a solar panel 110, a ball valve 109, a ball valve controller 111, a solar panel 110, and a communications device 106, including a Wi-Fi connection. Other than the pressure regulator 102, all of these components are the same as those described above and shown in FIGS. 1-6. The power supply 108 and solar panel 110 powers the communications device and may also power the pressure and flow sensor 104. The solar panel 110 becomes the main source of power in the absence of power connection to the electrical grid. The communications including a “Pinoccio” device 106 is connected to the pressure and flow sensor 104 and the ball valve controller 111, and allows for the remote monitoring and control of the pressure and flow parameters of the universal automated regulator valve 100. Other communications device including Bluetooth communication is supported. The communications device 106 may also be connected to the pressure regulator 102 to adjust the set pressure or the predetermined pressure that the pressure regulator 102 needs to maintain.

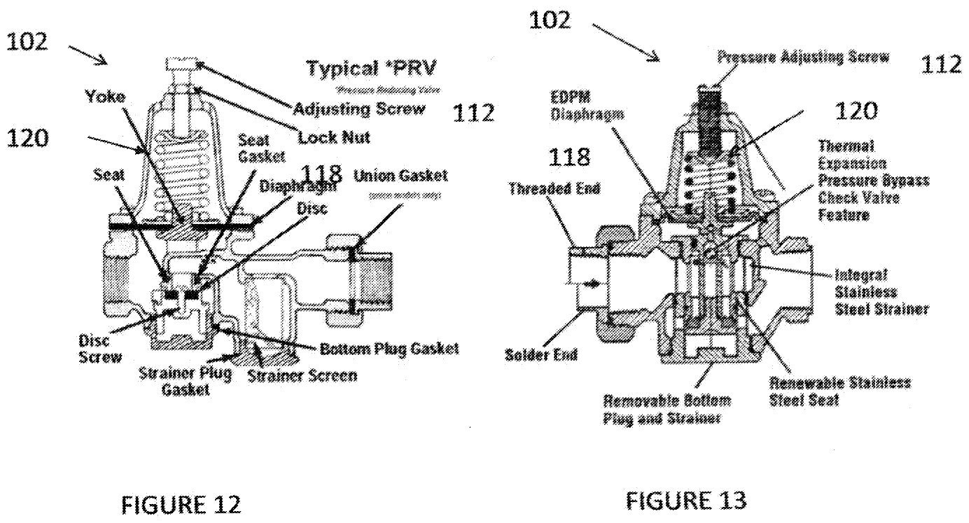

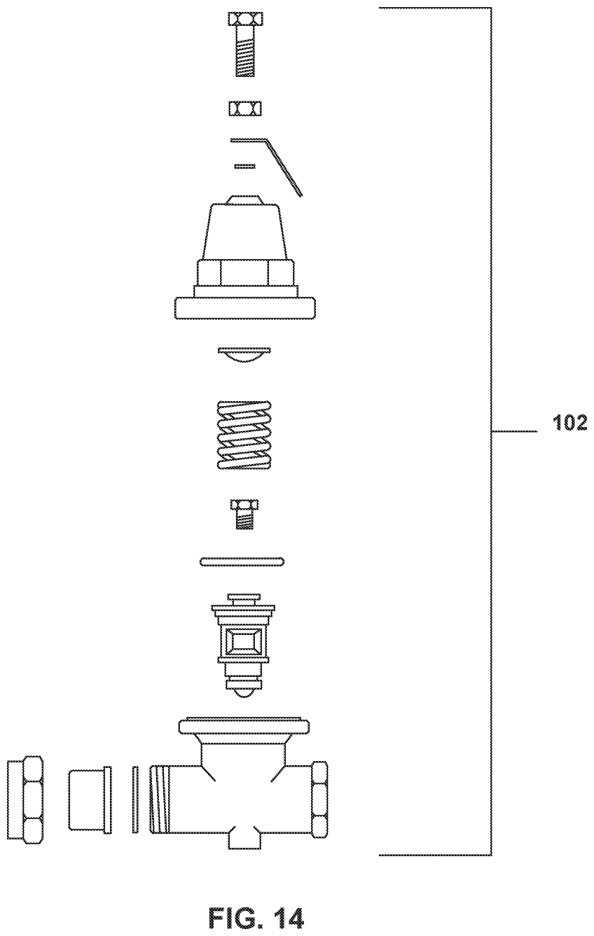

Referring now to FIGS. 12-14, some examples of pressure regulators 102 that is used are shown. Another pressure regulator that is used is Type 75A Water Pressure Regulator from Emerson Process Management Regulator Technologies, Inc. of McKinney, Tex., as described in Attachment B. In general, the pressure regulator includes an adjusting screw 112 to adjust the set pressure, which is the desired pressure to be maintained. The set pressure is low pressure or high pressure, as desired. The pressure regulator further includes input medium channels and output medium channels. If the input pressure in the input medium channel exceeds the set pressure, the medium is diverted over the valve channels that lead to the diaphragm 118. The diaphragm compresses upwards together with the piston 120, thereby causing the pressure regulator to open the output medium channel to vent the excess pressure. The pressure regulator then closes the output medium channel once the set pressure is attained. The pressure regulator opens and closes the output medium channels to achieve a constant system pressure. It is noted that the pressure regulator 102 is not limited to regulating any particular kind of medium. The pressure regulator 102 can regulate the pressure of water, gas, or any other medium.

In use, the universal automated regulator valve 100 is self-monitoring and self-regulating. It monitors discrepancies in the pressure or flow rate and it can adjust the pressure or flow rate to maintain a set pressure or flow rate. It is connected to the electronic ball valve so that when the pressure or flow rate discrepancy exceeds a threshold, the electronic ball valve is configured to shut down automatically. Their communication devices, including their Wi-Fi controllers, allow users to monitor and control them remotely using their computers or mobile devices. Their flow meters allow users to monitor consumption of gas or water, depending on the user's application.

The universal automated regulator valve of the present disclosure is used in water and gas lines in residential or commercial settings. Several wired or wireless gas or water leak sensors are positioned along the gas or water lines and connected to the universal automated regulator valve, including to ball valve controller. When the gas or water leak sensor senses a leak of a predefined pressure, flow, temperature the ball valve controller causes the ball valve to shut off flow to the system. An example of a gas sensor is BESTEK® Plug-In Combustible Gas Detector Alarm Sensor natural Gas Leak Sensor Detector Alarm with Voice Warning and LED Indicator, which is shown in FIG. 16.

While exemplary embodiments are described above, it is not intended that these embodiments describe all possible forms of the invention. Rather, the words used in the specification are words of description rather than limitation, and it is understood that various changes are made without departing from the spirit and scope of the invention. Additionally, the features of various implementing embodiments are combined to form further embodiments of the invention.

The foregoing has described the principles, embodiments and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

What is claimed is:

1. A digital automated regulation device for a pipeline conveying a fluid, comprising:
a digital regulation device controller;
an electronically actuated ball valve operatively coupled to the digital regulation device controller, the electronically actuated ball valve including a ball having a borehole and rotatable between a closed position, a fully open position, and at least one partially open position;
an electrical motor and a relay operatively coupled to the electronically actuated ball valve;
a plurality of fluid leak sensors coupled to the digital regulation device controller and positioned along an exterior of the pipeline, including at least one wireless fluid leak sensor;
a pressure sensor having an electrical pressure sensor switch coupled to the digital regulation device controller;
a flow-rate sensor coupled to the digital regulation device controller;
a temperature sensor coupled to the digital regulation device controller;
an automated regulator coupled to the digital regulation device controller, the electrical motor, the relay, and the electrical pressure sensor switch; and
wherein the digital regulation device controller is configured to monitor pressure, flow rate, and temperature of the fluid and signal the automated regulator to open or close the electronically actuated ball valve when a leak condition or abnormal operating condition is detected to maintain predetermined operating parameters of the fluid.

2. The digital automated regulation device for a pipeline with fluid of claim 1, further comprising an automated digital regulation device app operating on a mobile device, wherein the digital regulation device controller is remotely controlled by the mobile device.

3. The digital automated regulation device for a pipeline with fluid of claim 1, wherein the plurality of fluid leak sensors includes a sensor attached to the outside of the pipeline.

4. The digital automated regulation device for a pipeline with fluid of claim 2, wherein the digital regulation device app is further configured to transmit text message status alerts to the mobile device.

5. The digital automated regulation device for a pipeline with fluid of claim 1, wherein the automated digital regulation device is further configured to transmit an email to a user's mobile device detailing the conditions of at least one preset parameter activation.

6. The digital automated regulation device for a pipeline with fluid of claim 1, wherein the automated digital regulation device is further configured to transmit to a user's mobile device using an automated digital regulation device app an alert that the current conditions of the fluid movement are not within the preset parameters.

7. The digital automated regulation device for a pipeline with fluid of claim 1, further comprising an automated digital regulation device app installed on the user's mobile device configured to receive from at least one of the plurality of sensors and display pressure sensing data to allow the user to read the pressure sensing data on the user's mobile device.

8. A digital automated regulation device for a pipeline conveying a fluid, comprising:
a digital regulation device controller;
an electronically actuated ball valve operatively coupled to the digital regulation device controller, the electronically actuated ball valve including a ball having a borehole and rotatable between a closed position, a fully open position, and at least one partially open position;
an electrical motor and a relay operatively coupled to the electronically actuated ball valve;
a plurality of fluid leak sensors coupled to the digital regulation device controller and positioned along an exterior of the pipeline, including at least one wireless fluid leak sensor;
a pressure sensor having an electrical pressure sensor switch coupled to the digital regulation device controller;
a flow-rate sensor coupled to the digital regulation device controller;
a temperature sensor coupled to the digital regulation device controller;
an automated regulator coupled to the digital regulation device controller, the electrical motor, the relay, and the electrical pressure sensor switch;
an automated digital regulation device application installed on a user's mobile device and communicatively coupled to the digital regulation device controller;
wherein the digital regulation device controller is configured to monitor pressure, flow rate, and temperature of the fluid and signal the automated regulator to open or close the electronically actuated ball valve when a leak condition or abnormal operating condition is detected to maintain predetermined operating parameters of the fluid; and
wherein the automated digital regulation device application is configured to receive sensor data from the digital regulation device controller and display the sensor data on the user's mobile device.

9. The digital automated regulation device for a pipeline with fluid of claim 8, wherein should the automated digital regulation device fail to adjust and maintain the preset parameters the automated digital regulation device will shut down automatically and send the user alerts via text and email.

10. The digital automated regulation device for a pipeline with fluid of claim 8, wherein the flow rate sensor is further configured to continuously measure the flow rate and whenever the flow rate exceeds the predetermined maximum flow rate the flow rate sensor signals closure of the electronically actuated ball valve.

11. The digital automated regulation device for a pipeline with fluid of claim 8, further comprising at least one automated regulator coupled to the digital regulation device controller configured to allow a remote user interaction with a remote server with artificial intelligence and machine learning for dynamically adjusting fluid flow or pressure and to eliminate water hammer also based on control signals from the digital regulation device controller.

12. The digital automated regulation device for a pipeline with fluid of claim 8, wherein the automated digital regulation device is further configured for use in homes, farms, and commercial buildings for fluids including water, gas, petroleum oil, natural gas, liquid propane, diesel fuel, and fluids that can be pressurized and controlled under an automated digital regulation device all regulation devices.

13. The digital automated regulation device for a pipeline with fluid of claim 8, further comprising the controller configured to monitor environmental factors such as seismic activity and automatically stop the flow of the fluid.

14. The digital automated regulation device for a pipeline with fluid of claim 8, wherein at least one of the plurality of sensors is configured to detect leaks along pipelines conveying a fluid, wherein the sensor identification and location detecting the leak facilitates locating leaks for repairs to stop the leak.

15. A digital automated regulation device for a pipeline conveying a fluid, comprising:
a digital regulation device controller;
an electronically actuated ball valve operatively coupled to the digital regulation device controller, the electronically actuated ball valve including a ball having a borehole and rotatable between a closed position, a fully open position, and at least one partially open position;
an electrical motor and a relay operatively coupled to the electronically actuated ball valve;
a plurality of fluid leak sensors coupled to the digital regulation device controller and positioned along an exterior of the pipeline, including at least one wireless fluid leak sensor;
a pressure sensor having an electrical pressure sensor switch coupled to the digital regulation device controller;
a flow-rate sensor coupled to the digital regulation device controller;
a temperature sensor coupled to the digital regulation device controller;
an automated regulator coupled to the digital regulation device controller, the electrical motor, the relay, and the electrical pressure sensor switch;
an automated digital regulation device application installed on a user's mobile device and communicatively coupled to the digital regulation device controller; and
wherein the digital regulation device controller is configured to monitor pressure, flow rate, and temperature of the fluid and signal the automated regulator to open or close the electronically actuated ball valve when a leak condition or abnormal operating condition is detected to maintain predetermined operating parameters of the fluid.

16. The digital automated regulation device for a pipeline with fluid of claim 15, wherein the automated regulator is configured to regulate pressure and flow rate of the fluid by selectively rotating the ball to the fully open position, the closed position, or the at least one partially open position to adjust fluid flow through the borehole.

17. The digital automated regulation device for a pipeline with fluid of claim 15, further comprising an automated digital regulation device app operating on a mobile device, wherein the digital regulation device controller is remotely controlled by the mobile device.

18. The digital automated regulation device for a pipeline with fluid of claim 15, wherein the plurality of fluid leak sensors includes a sensor attached to the outside of the pipeline.

19. The digital automated regulation device for a pipeline with fluid of claim 15, wherein the digital regulation device app is further configured to transmit text message status alerts to the mobile device.

20. The digital automated regulation device for a pipeline with fluid of claim 15, wherein the automated digital regulation device is further configured to transmit an email to a user's mobile device detailing the conditions of at least one preset parameter activation.
